(19) United States
(12) Patent Application Publication
(10) Pub. No.: US 2020/0396545 A1
(43) Pub. Date: Dec. 17, 2020

(54) Screen Sounding Device

(71) Applicant: AAC Technologies Pte. Ltd., Singapore city (SG)

(72) Inventors: Zhaoxian Chen, Shenzhen (CN); Lubin Mao, Shenzhen (CN)

(21) Appl. No.: 16/996,943

(22) Filed: Aug. 19, 2020

Related U.S. Application Data
(63) Continuation of application No. PCT/CN2019/091211, filed on Jun. 14, 2019.

(30) Foreign Application Priority Data
Jun. 12, 2019 (CN) 201910506417.8

(51) Int. Cl. H04R 9/06; H04M 1/02; H04R 9/02; H04R 11/02

(52) U.S. Cl. CPC H04R 9/06; H04M 1/0266; H04R 1/028; H04R 11/02; H04R 2400/11; H04R 9/025

(57) ABSTRACT

The invention discloses a screen sounding device including a screen, a frame, and an electromagnetic driving module. The electromagnetic driving module includes an electromagnet, a magnet and a spring. Electromagnet includes a magnetic core and a coil wound around the outer periphery of the magnetic core. By changing the magnitude of the electric current flowing into the coil, the strength of the driving force can be controlled, so as to provide a greater driving force and obtain a better sound performance. Moreover, the driving module of the present invention has a simple structure and can be easily installed. Because the amplitude of the screen vibration is small, the sounding device can be made very thin. Compared with traditional speaker and receiver, the structure such as the diaphragm is omitted, and the production cost is lower.

### FIELD OF THE PRESENT DISCLOSURE

The invention relates to the field of electroacoustic conversion technology, especially relating to a screen sounding device.

### DESCRIPTION OF RELATED ART

With the rapid development of technology, more and more electronic devices are equipped with acoustic functions. However, the acoustic function of the electronic device is realized through sounding device. Many electronic devices have multiple functions such as video playback, music playback and navigation prompts, etc. in order to be easily controlled and carried. Electronic devices are being developed in a more refined trend. However, the more electronic components disposed in the sounding device results in less reliable.

For example, the driving unit used in the sounding device of the existing mobile phone is classified into a piezoelectric type and a moving coil type. The sounding device is inside the entire mobile phone and connects the mobile phone middle frame (or back cover) and the mobile phone screen as a whole device or a distributed device. However, using a driving device of piezoelectric type requires a larger voltage. The moving coil type driving device has a complicated structure and the size of the sounding device is difficult to be made smaller. And the driving force is limited. As a result, the sound performance is not so good.

### SUMMARY OF THE INVENTION

One of the main objects of the invention is to provide a screen sounding device with simplified structure and greater driving force to generate better sound performance

For achieving the above mentioned object, the invention provides a screen sounding device including a screen, a frame, and an electromagnetic driving module. The electromagnetic driving module includes an electromagnet, a magnet and a spring. Electromagnet includes a magnetic core and a coil wound around the outer periphery of the magnetic core. By changing the magnitude of the electric current flowing into the coil, the strength of the driving force can be controlled, so as to provide a greater driving force and obtain a better sound performance. Moreover, the driving module of the present invention has a simple structure and can be easily installed. Because the amplitude of the screen vibration is small, the sounding device can be made very thin. Compared with traditional speaker and receiver, the structure such as the diaphragm is omitted, and the production cost is lower.

As an improvement, the electromagnetic driving module includes multiple magnets distributed along a periphery of the electromagnet, a connection covering plate; top parts of the multiple magnets are all fixedly connected to the connection covering plate, and the connection covering plate is fixed below the screen.

As an improvement, the electromagnetic driving module further includes a connection bottom plate; bottoms of the plurality of magnets are all fixedly connected to the connection bottom plate.

As an improvement, the connection covering plate and the connection bottom plate are both made of the magnetic conduction material.

As an improvement, the electromagnetic driving module includes a ring magnet surrounding the periphery of the electromagnet.

As an improvement, the first connection parts are provided on two opposite sides of the second connection part of the spring; both ends of the first connection part are fixedly connected to the second connection part through the elastic deformation part.

As an improvement, the electromagnetic driving module further comprises a magnetic conduction covering plate covering the top surface of the electromagnet; a bottom surface of the magnetic conduction covering plate is bonded to the top surface of the electromagnet; the bottom surface of the second connection part of the spring is fixedly connected to the top surface of the magnetic conduction covering plate.

As an improvement, the electromagnetic driving module further includes a magnetic conduction plate disposed on the bottom surface of the electromagnet; the top of the magnetic conduction plate is bonded to the bottom surface of the electromagnet.

As an improvement, the screen includes a glass panel and a display screen both installed on the frame; the glass panel is stacked on the display screen; a length of the display screen is shorter than a length of the glass panel; the electromagnetic driving module is placed below the glass panel and staggered with the display screen; an end of the electromagnetic driving module connecting with the spring is close to the glass panel.

As an improvement, the magnet is magnetized along a vibration direction of the screen.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is an isometric view of a screen sounding device in accordance with a first embodiment of the present invention;

FIG. 2a is a cross-sectional view of the screen sounding device taken along Line A-A in FIG. 1;

FIG. 2b is an enlarged view of Part A in FIG. 2a;

FIG. 3 is an exploded view of the screen sounding device in FIG. 1;

FIG. 4 is an isometric view of an electromagnetic driving module of the present invention;

FIG. 5 is a cross-sectional view of the electromagnetic driving module taken along line b-b in FIG. 4;

FIG. 6 is an exploded view of the electromagnetic driving module in

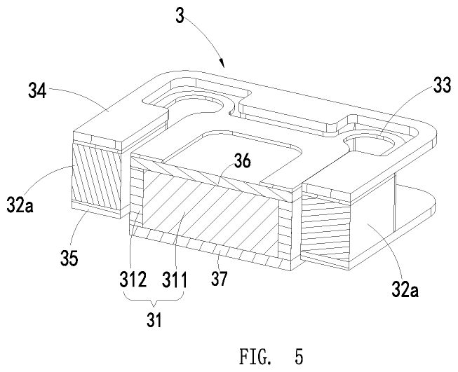

FIG. 4;

FIG. 7 is an exploded view of an electromagnetic driving module of the screen sounding device in accordance with a second embodiment of the present invention.

### DETAILED DESCRIPTION OF THE EXEMPLARY EMBODIMENTS

The present disclosure will hereinafter be described in detail with reference to several exemplary embodiments. To make the technical problems to be solved, technical solutions and beneficial effects of the present disclosure more apparent, the present disclosure is described in further detail together with the figure and the embodiments. It should be understood the specific embodiments described hereby are only to explain the disclosure, not intended to limit the disclosure.

In the description of the present invention, it should be noted that the azimuth or positional relationship indicated by terms like “center”, “upper”, “lower”, “left”, “right”, “vertical”, “horizontal”, “inner”, “outer”, etc. is based on the azimuth or positional relationship shown in the drawings in order to facilitate the description of the present invention and simplify the description, rather than indicating or implying that the device or element referred to must have a specific orientation and be constructed in a specific orientation and operation. Therefore it cannot be understood as a limitation of the present invention. The terms “first”, “second”, and “third” are only used for descriptive purposes and cannot be understood as indicating or implying relative importance. In addition, unless otherwise clearly specified and defined, the terms “installation”, “connected” “ ” and “connection” should be understood in a broad sense. For example, it can be a fixed connection, a detachable connection or an integral connection. It can also be a mechanical connection or an electrical connection. It can be directly connected or indirectly connected through an intermediary or the connection between two components. For those of ordinary skill in the field, the specific meanings of the above terms in the present invention can be understood in specific situations.

### First Embodiment

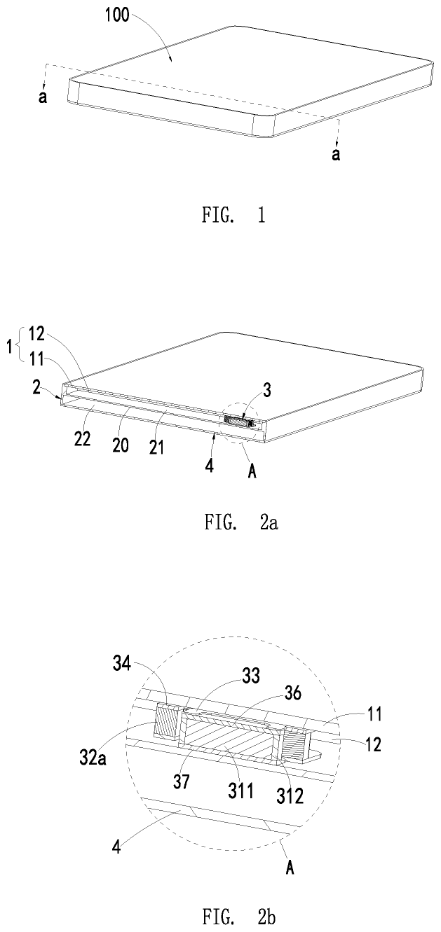

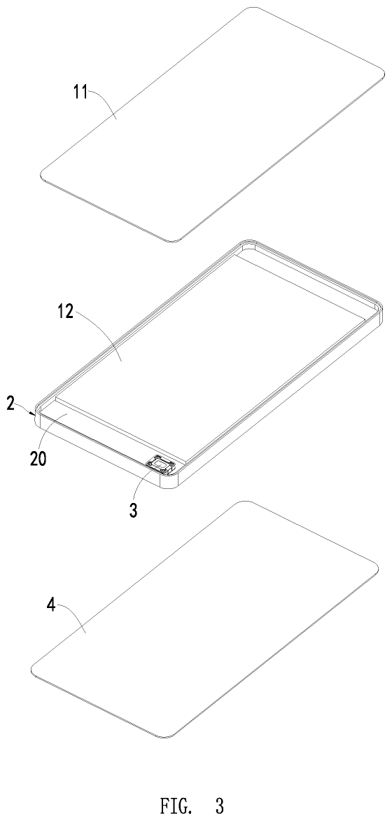

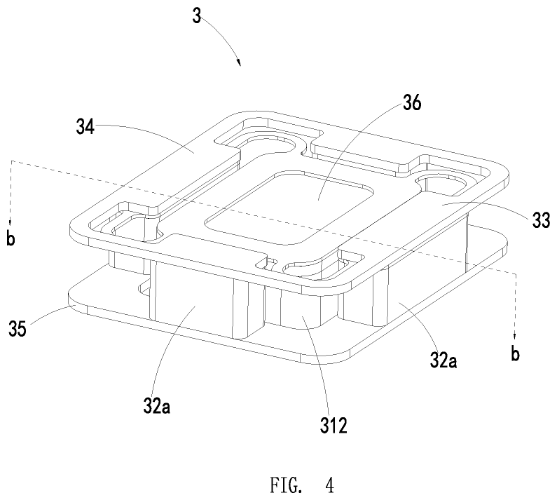

Please refer to FIGS. 1-3, a screen sounding device 100 provided in this embodiment includes a screen 1 for vibration and sound, a frame 2 for installing the screen 1, an electromagnetic driving module 3 for driving the screen 1 to vibrate, and a back cover 4.

The frame 2 is a long middle frame with a middle division plate 20 in the middle. The middle division plate 20 divides the frame 2 into two separated spaces, an upper space 21 and a lower space 22. The electromagnetic driving module 3 is installed on the middle division plate 20 of the frame 2 and is placed in the upper space 21. The back cover 4 covers the lower space 22 of the frame 2.

The above screen 1 includes a glass panel 11 and a display screen 12. The glass panel 11 and the display screen 12 are both installed on the frame 2. The glass panel 11 is stacked on the display screen 12. A length of the display screen 12 is smaller than a length of the glass panel 11. The electromagnetic driving module 3 is placed below the glass panel 11 and staggered with the display screen 12. In practical applications, the glass panel 11 may be a touch panel or only a general glass panel 11.

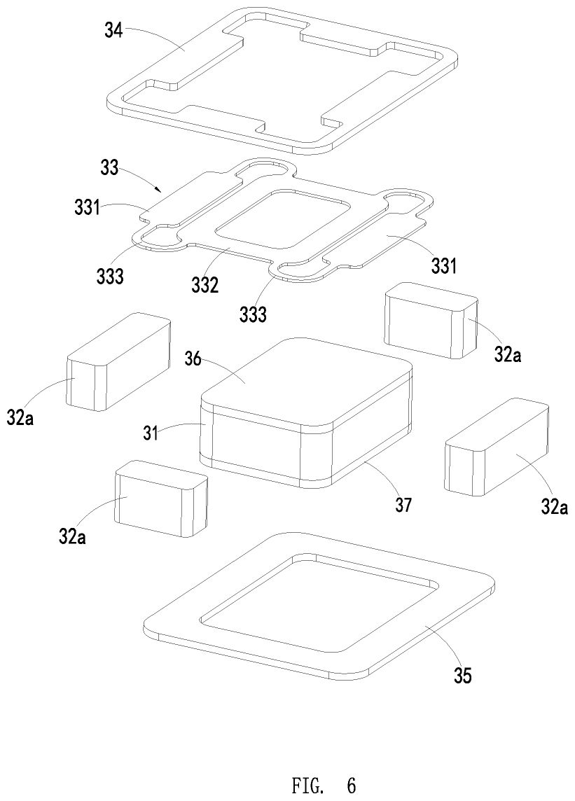

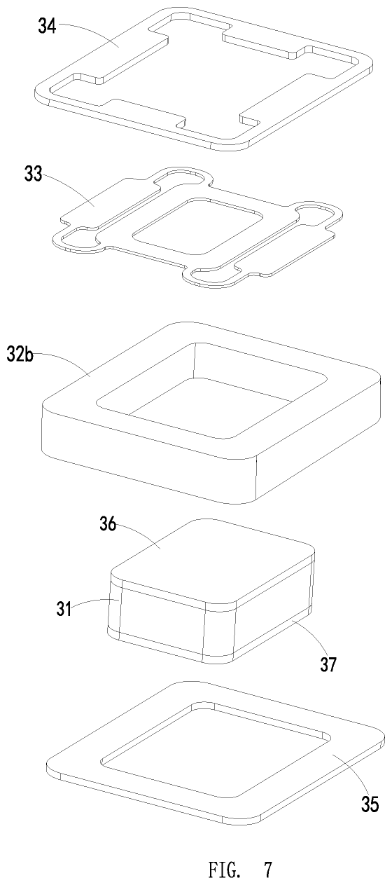

Please refer to FIGS. 4-6. The electromagnetic driving module 3 includes an electromagnet 31, a plurality of magnets 32a and a spring 33. The electromagnet 31 includes a magnetic core 311 and a coil 312 wound around an outer periphery of the magnetic core 311.

The plurality of magnets 32a are distributed along the periphery of the electromagnet 31 and are separated from the outer side surface of the electromagnet 31 by a gap. In this embodiment, the magnet 32a is magnetized along the vibration direction of the screen 1.

The spring 33 of this embodiment is formed by stamping and in the shape of a sheet in the whole. The spring 33 is provided with a first connection part 331, a second connection part 332 and an elastic deformation part 333. The elastic deformation part 333 is connected between the first connection part 331 and the second connection part 332. The first connection part 331 is fixedly connected to the magnet 32a and the second connection part 332 is fixedly connected to the electromagnet 31.

Further, the electromagnetic driving module 3 also includes a connection covering plate 34, a connection bottom plate 35, a magnetic conduction covering plate 36 and a magnetic conduction plate 37.

The connection covering plate 34 is fixed under the glass panel 11. All the top parts of the magnet 32a are fixedly connected to the bottom surface of the connection covering plate 34. The bottom of all the magnet 32a is fixedly connected to the top surface of the connection bottom plate 35. Through the connection covering plate 34 and the connection bottom plate 35, all magnet 32a can be connected into a whole. Preferably, the connection covering plate 34 and the connection bottom plate 35 are all made of the magnetic conduction material. So under the influence of the magnet 32a, the connection covering plate 34 and the connection bottom plate 35 also have magnetism. Therefore, a magnetic circuit can be formed around the electromagnet 31, making the force of the magnet 32a on the electromagnet 31 more uniform and more comprehensive.

In order to allow the spring 33 to connect to the magnet 32a distributed on two outer sides of the electromagnet 31, first connection parts 331 are arranged at both opposite sides of the second connection part 332 of the spring 33, both ends of the first connection part 331 are fixedly connected to the second connection part 332 through the elastic deformation part 333.

The magnetic conduction covering plate 36 is covered on the top surface of the electromagnet 31. The bottom surface of the magnetic conduction covering plate 36 is bonded to the top surface of the electromagnet 31. The bottom surface of the second connection part 332 of the spring 33 is fixedly connected to the top surface of the magnetic conduction covering plate 36. The magnetic conduction plate 37 is covered on the bottom surface of the electromagnet 31. The top surface of the magnetic conduction plate 37 is bonded to the bottom surface of the electromagnet 31. Through the magnetic conduction covering plate 36 and the magnetic conduction plate 37, the magnetic core 311 and the coil 312 can be connected into a whole electromagnet 31 and the magnetism on the electromagnet 31 can be guided to the magnetic conduction covering plate 36 and the magnetic conduction plate 37 to make the magnetic field intensity distribution more uniform.

The above-mentioned electromagnetic driving module 3 is clamped and arranged between the middle division plate 20 and the glass panel 11 of the frame 2 as a whole component, wherein the electromagnet 31, the magnetic conduction covering plate 36 and the magnetic conduction plate 37 are fixed on the frame 2. The magnet 32a and the connection covering plate 34 connected to the magnet 32a. And the connection bottom plate 35 are all fixed under the glass panel 11.

In the sounding device 100 of this embodiment, the electromagnet 31 of the electromagnetic driving module 3 can generate a magnetic field after being energized. The electromagnet 31 interacts with the magnet 32a to drive the magnet 32a to vibrate and drive the screen 1 to vibrate and makes sound. By changing the size of the electric current flowing into the coil 312, the size of the driving force can be controlled, which can provide a larger driving force and obtain a better sound effect. In addition, the electromagnetic driving module 3 of this embodiment is connected by the spring 33 into an integrated structure, which is simple in structure and easy to install. At the same time, because the vibration amplitude of the screen 1 is small, the entire sounding device 100 can be made very thin and the size can be made smaller. Compared with the traditional speaker and receiver, the structure omits diaphragm and the production cost is lower.

### Second Embodiment

Please refer to FIG. 7. The difference between this embodiment and the first embodiment is that the electromagnetic driving module 3 of the screen sounding device of this embodiment uses a ring magnet 32b, the ring magnet 32b surrounds the periphery of electromagnet 31. This embodiment uses the ring magnet 32b to produce a magnetic field with a more uniform strength. When necessary, the connection covering plate 34 and the connection bottom plate 35 for connecting multiple magnets can also be omitted.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A screen sounding device including:
a screen for vibrating and radiating sound;
a frame for installing the screen;
an electromagnetic driving module for driving the screen to vibrate, including an electromagnet having a magnetic core and a coil wound on the outer periphery of the magnetic core, a magnet outside the electromagnet and separated from an outer side surface of the electromagnet by a gap, and a spring provided with a first connection part, a second connection part and an elastic deformation part connected between the first connection part and the second connection part; wherein
the first connection part is fixedly connected to the magnet and the second connection part is fixedly connected to the electromagnet; the electromagnet is fixed on the frame, and the magnet is fixed under the screen.

2. The screen sounding device as described in claim 1, wherein the electromagnetic driving module includes multiple magnets distributed along a periphery of the electromagnet, a connection covering plate; top parts of the multiple magnets are all fixedly connected to the connection covering plate, and the connection covering plate is fixed below the screen.

3. The screen sounding device as described in claim 2, wherein the electromagnetic driving module further includes a connection bottom plate; bottoms of the plurality of magnets are all fixedly connected to the connection bottom plate.

4. The screen sounding device as described in claim 3, wherein the connection covering plate and the connection bottom plate are both made of the magnetic conduction material.

5. The screen sounding device as described in claim 1, wherein the electromagnetic driving module includes a ring magnet surrounding the periphery of the electromagnet.

6. The screen sounding device as described in claim 1, wherein the first connection parts are provided on two opposite sides of the second connection part of the spring; both ends of the first connection part are fixedly connected to the second connection part through the elastic deformation part.

7. The screen sounding device as described in claim 1, wherein the electromagnetic driving module further comprises a magnetic conduction covering plate covering the top surface of the electromagnet; a bottom surface of the magnetic conduction covering plate is bonded to the top surface of the electromagnet; the bottom surface of the second connection part of the spring is fixedly connected to the top surface of the magnetic conduction covering plate.

8. The screen sounding device as described in claim 7, wherein the electromagnetic driving module further includes a magnetic conduction plate disposed on the bottom surface of the electromagnet; the top of the magnetic conduction plate is bonded to the bottom surface of the electromagnet.

9. The screen sounding device as described in claim 1, wherein the screen includes a glass panel and a display screen both installed on the frame; the glass panel is stacked on the display screen; a length of the display screen is shorter than a length of the glass panel; the electromagnetic driving module is placed below the glass panel and staggered with the display screen; an end of the electromagnetic driving module connecting with the spring is close to the glass panel.

10. The screen sounding device as described in claim 1, wherein the magnet is magnetized along a vibration direction of the screen.
